(19) United States
(12) Patent Application Publication
(10) Pub. No.: US 2008/0066095 A1
(43) Pub. Date: Mar. 13, 2008

(54) IPTV blackout management

(75) Inventor: Ramiro Reinoso, Holland, PA (US)

Correspondence Address: THELEN REID BROWN RAYSMAN & STEINER LLP, 2225 EAST BAYSHORE ROAD, SUITE 210, PALO ALTO, CA, 94303, US

(73) Assignee: SES AMERICOM, Inc.

(21) Appl. No.: 11/511,932

(22) Filed: Aug. 28, 2006

(51) Int. Cl. H04N 7/173; H04N 7/20; H04N 7/16

(52) U.S. Cl. 725/28; 725/110; 725/112; 725/63

(57) ABSTRACT

IPTV-based systems offer acquisition and distribution of content from numerous channels with protected end-to-end conditional access. In adopting IPTV-based systems for seamless transport and blackout management of the content, service providers would need an IPTV-based transport architecture that accommodates their existing infrastructure and provides transparent live events content blackout management. In the spectrum of service providers some have no physical infrastructure at all and some have the entire suite of infrastructure and services. Therefore, the present invention provides a new IPTV-based transport system architecture that can accommodate the spectrum of service providers, including tier-1, tier-2 and tier-3 telcos. Such architecture includes double-layer encryption and bulk decryption in addition to encapsulation that allows seamless transition from programs to alternate programs in designated blackout areas.

### FIELD OF ART

The present invention relates to data communications for live event content blackout management, which, in a typical example, involve broadband data distributed over a secure, tightly managed network using a method known as IPTV (Internet Protocol Television).

### BACKGROUND

The economics of sports mobilized sport league managers to enter into agreements with television (TV) and cable networks (content providers) allowing them to telecast sports events. TV rights of content providers are often limited to areas within which telecasts of live sporting events such as National or American football League games may be made. However, telecasts of live sporting events are excluded from areas surrounding the venue of such sporting events in order to increase spectator tickets sales at these events. In such areas, telecasts are said to be in a ‘blackout’ mode. In principle, other types of events could be subject to this so-called blackout but because most often it involves sporting events the discussion here focuses on sporting events.

One way blackouts can be avoided where live sporting events are allowed to air locally is if tickets at the venue are sold out in advance of the scheduled event start time. However, sporting event tickets don't always sell out at the venues and blackouts cannot be avoided. Thus, network control systems exist that may include blackout management for live sporting events that addresses the rules and regulations surrounding these blackouts.

Because of the growing ubiquity of broadband communications for transporting content, and the recent adoption of IPTV (Internet protocol television) technology, network control systems that include some form of blackout mechanism are deployed on IPTV platforms. IPTV is a method for streaming content over broadband connections like DSL lines and satellites. In general, IPTV offers more channels, picture-in-picture, on-screen guides, video on demand (VoD), gaming, on-screen caller ID, on-screen chat or email, interaction with other Internet services and more. For instance, with IPTV, using suitable data transport protocols and video and audio compression standards, data transport can be customized to specific users in that IPTV allows the service provider to deliver, rather than all channels to every consumer on the network, only those channels that the consumers want at any given time. Moreover, IPTV provides interactive TV capability where consumers can view a program while also accessing information about it, such as looking at statistics and live footage of one game while watching another. Other interactive TV capabilities available with IPTV include the ability of geographically distant consumers to watch programs ‘together but remotely’ while simultaneously exchanging messages between them, as well as the ability to exchange data such as home movies and still photos between consumers, receive caller identification on the TV set, employ time shifting, remotely control TV viewing and more.

However, blackout management in connection with the delivery of sports content over IPTV (Internet protocol television) networks presents challenges. One challenge involves filling the blanks created during blackouts. To avoid perceived disruption of the service, it is desirable to seamlessly and transparently replace original sporting event programs with substitutes during blackout periods.

### SUMMARY

The present invention addresses these and related issues by introducing a new platform and methods for handling blackout management in an IPTV-based system. The new platform is designed with IPTV-based transport system architecture for allowing blackout management to carry out its functions seamlessly and transparently. For the purpose of the invention as shown broadly described herein, various embodiments of the invention either deploy or make use of this platform.

One embodiment is a method for managing blackouts of content distributed in an IPTV-based system. This method includes receiving content that includes a program and one or more alternate programs. The content may be video, audio, audiovisual or multimedia data. Once the content is received the method proceeds to perform encapsulation on packets of the content, wherein the encapsulation re-addresses the packets. As a result, the alternate program is re-addressed similarly to the program such that both are sent to the same destination and enable de-encapsulation at this destination to expose the packets of content. The re-addressing of packets re-assigns their IP multicast addresses. Then, if this destination is designated for blackout of the program, the program and the alternate program are identified to this destination by their respective program identifications (PIDs) so that the destination can replace the program by the alternate program substantially seamlessly and transparently. At the destination there is a receiving head-end associated with a particular zip code area and operative to respond to blackout commands directed to that zip code area. This is done by turning off the program channel and turning on the appropriate alternate program channel both of which are identified to the receiving head-end by their respective PIDs. Thus, once encapsulation is done the packets are sent in encapsulated form to the destination via a wireless or satellite link.

According to this method, the blackout commands originate with a programmer that also provides the content, or with a scheduling system, such as an SES Americom, Inc. operated scheduling system, located in a network operations center. The content includes streams from multiple channels, one channel is associated with the program and another channel or group of channels is associated with the alternate programs. That is, one channel corresponds to the main national feed with the program to be blocked and other channel(s) correspond to secondary feeds with alternate programs. The content is packaged for transmission in IP packets.

Accordingly, in this instance the encapsulation forms content transport packets by dividing the IP packets into, say, 188-bit segments and encapsulating each with an envelope that includes a header. Preferably, the segments conform to the point-to-point transmission protocol, e.g. MPEG-2 protocol, and thus segments associated with the content of the same program share the same PID. This means that each header includes a PID that associates the segment to a particular program with such PID, where the PID corresponds to a particular program source address. This means also that each packet has a header with an original IP address, and the encapsulation re-addresses the IP addresses of all channels to the IP address of the main channel (main program feed), and inserts ahead of such header an outer header with the corresponding PID.

At the destination of the transport packets the receiving head-end de-encapsulates them. In essence, de-encapsulation exposes the header with its re-addressed IP address and then reconstructs the IP packet from the transport packets whose header contains the same PID. In other words, de-encapsulation re-assembles the IP packet from the segments based on the information in the exposed header.

Note that in a typical system implementation where this method might be used the encapsulated packets undergo double-layer encryption before they are sent to the destination. For the double-layer encryption the method further includes performing inner-layer encryption of the received content and producing a double-layer-encrypted content by performing outer-layer encryption of the inner-layer-encrypted content. At the destination, the receiving head-end is operative to receive the encapsulated packets in double-layer-encrypted form for delivery to at least one of high-tier and low-tier service provider networks (high and low tier service providers are more fully described later in this document). This involves decrypting the double-layer-encrypted content by performing outer layer decryption to yield the inner-layer encrypted content, where the low tier service provider networks carry the yielded inner-layer-encrypted content. This further involves decrypting the yielded inner-layer-encrypted content by performing inner layer decryption to expose the content, where the exposed content is securely handed off to a high tier service provider's controlled access system for re-encryption before being passed on to the high tier service provider network.

Another embodiment is an IPTV-based system for blackout management that includes a receiver for receiving content, a transmitter for sending the content in encapsulated double-layer-encrypted form to at least one of high-tier and low-tier service provider networks, and a wireless or satellite link for relaying the transmitted content.

For the double layer encryption, the system includes an inner layer encryption engine operative to perform inner-layer encryption of received content. The outer layer encryption engine is operative to perform outer layer encryption of the inner-layer-encrypted content. Incidentally, if, in one implementation, the encryptions to be performed in the inner layer encryption engine and outer layer encryption engine are both compliant with digital video broadcasting (DVB) standards each of them uses a separate encryption key. Either way, the outer layer encryption produces the double-layer-encrypted content so that decryption thereof would yield the inner-layer-encrypted content for acquisition by one of the low-tier service provider networks. Moreover, bulk decryption of the yielded inner-layer-encrypted content would expose the content for acquisition by one of the high-tier service provider networks.

Such IPTV-based system further includes an encapsulation engine. Because the content includes streams from multiple channels, the encapsulation engine is operative to bundle streams from groups of the channels into IP packets. The encapsulation engine is further operative to insert an outer header with the aforementioned program's PID ahead of an IP packet's original header such that de-encapsulation would expose the original header with its original IP address. The transmitted IP packets convey the PID to allow the receiving head-end at the destination to identify the program and alternate program and, in response to a blackout command, turn off the program and turn on the alternate program. This way, the content of a live event can blacked out in an area close to the venue of the event and an alternate program can be provided instead. With the re-addressing of the IP multicast address and PID the transition from the program to alternate program can be seamless and transparent to the viewers.

In yet another IPTV-based system, a receiver is operative to receive the double-layer encrypted content from a satellite or wireless link and, after de-encapsulation and response to any blackout commands as described above, to deliver the content to at least one of high-tier and low-tier service provider networks. To this end this system includes an outer layer decryption engine and an inner layer decryption engine. The received double-layer encrypted content is content that has undergone inner-layer encryption and outer-layer encryption, as described before. The outer layer decryption engine is operative to perform outer layer decryption of the received double-layer-encrypted content in order to yield inner-layer-encrypted content for acquisition by one of the low-tier service provider networks. Moreover, the inner layer decryption engine is operative to perform bulk inner-layer decryption of the yielded inner-layer-encrypted content in order to expose the content for acquisition by one of the high-tier service provider networks.

Note that in an IPTV-based system with either of these configurations the high-tier service provider network includes a secure handoff for passing the exposed content and a conditional access system with encoding and encryption capability for further protection of the exposed content. The low-tier service provider network is operative to carry through the inner-layer-encrypted content so that the content remains protected. The service provider networks are connected to TV (television) sets via associated set-top boxes. The set-top boxes have encryption engines for exposing the content when authorized and relaying the exposed content to their associated TV sets.

In sum, IPTV-based systems and methods in accordance with principles of the present invention provide blackout management in conjunction with the wireless or satellite distribution of content. Such distribution can be complemented by a fiber optic cable distribution. Such systems and methods use a single platform with a transport architecture that is common to and accommodates different types of service providers, be it tier-1 or tier-2,3 service providers. This and other features, aspects and advantages of the present invention will become better understood from the description herein, appended claims, and accompanying drawings as hereafter described.

### BRIEF DESCRIPTION OF THE DRAWINGS

The accompanying drawings, which are incorporated in and constitute a part of this specification, illustrate various aspects of the invention and together with the description, serve to explain its principles. Wherever convenient, the same reference numbers will be used throughout the drawings to refer to the same or like elements.

FIG. 1 illustrates an IPTV-based system in which various aspects of the invention are embodied.

FIG. 2 illustrates the flow of content in an IPTV-based system.

FIG. 3 illustrates with greater detail an IPTV-based system with various aspects of the invention.

### DETAILED DESCRIPTION

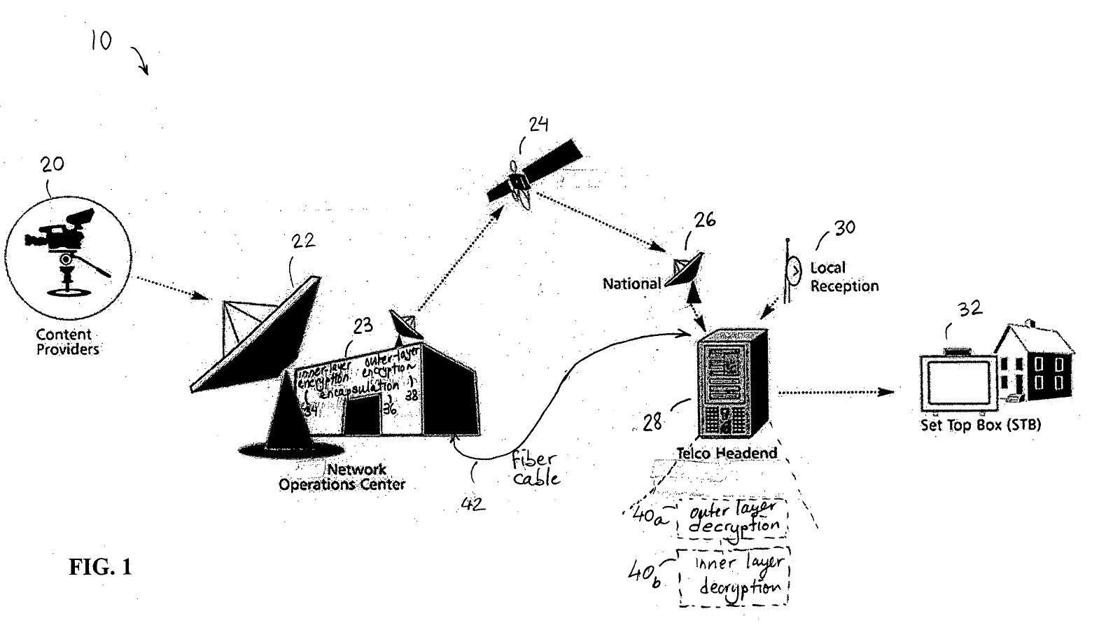

The present invention relates to Internet protocol television (IPTV) in that it contemplates handling blackout management in an IPTV-based system. This system provides a platform with IPTV-based transport architecture for carrying out blackout management functions seamlessly and transparently to the viewer. For this purpose, the transport architecture is designed with packet encapsulation functionality and various other transport functions including one or more forms of encoding, decoding, compression, decompression, encryption, and decryption functions. Accordingly, FIG. 1 is a diagram of an exemplary IPTV-based system 10 that embodies an IPTV-based transport system architecture in accordance with principles of the present invention.

Generally speaking, IPTV-based systems deliver broadband data services with two-way and point-to-point distribution capability. Such services are often provided in conjunction with live TV (multicasting) and stored video (video on demand or VoD).

IPTV-based systems allow more than live TV and VoD service over the broadband IP networks in that they enable Internet services such Web access and VoIP (voice over IP). This so-called triple play service delivers to consumers a bundled service of telephony, data and video. Because service providers of various types tend to occupy the triple play service space, either alone or in aggregation with counterparts, IPTV has emerged as a technology of choice for providing these types of services. For this reason an IPTV-based system is preferably designed to provide a scalable flexible platform which is compatible with established large operators, the so-called tier-1 service providers, as well as small operators and new corners, the so-called tier-2 and tier-3 service providers.

Representative service providers are cable companies and common carriers (e.g., telephone companies, known as telco companies). Service providers use their infrastructure to deliver to subscribers video programs from TV programmers and, if deployed in such infrastructure, also telephony and web access services. Indeed, in a departure from the traditional cable-satellite-only domain, along with VoIP providers, cable multi-service operators (MSOs) have been early adopters of the IPTV technology by offering the triple play services. However, not all service providers have the same capabilities and infrastructure for providing the forgoing services. Service providers are divided into tiers based on their capabilities and, often times, size. For instance, the larger, tier-1 service providers have more customization and network management capabilities while smaller tier-2 and tier-3 service providers have fewer network management and customization capabilities. Relatively speaking, in a given market, a tier-1 carrier is a large telco or ISP (internet service provider) that operates its own physical networks that include both physical access networks and long haul networks. Many in the direct TV service and cable industry tend to also correlate size with the number of access lines. Based on such measure, the large service providers with millions of access lines (e.g., 8,000,000 or more access lines) are more likely to be considered Tier-1 service providers. Moreover, Tier-1 service providers are also more likely to have the necessary infrastructure for launching IPTV service, including MPEG4 encoders, conditional access or digital rights management infrastructure, set-top boxes, video on demand (VoD) infrastructure, and so on.

By comparison, Tier-2 service providers are smaller telcos and ISPs that have their own physical access networks but not necessarily long haul networks. Tier-2 service providers may have access lines in the range of hundreds of thousands to few millions of access lines (e.g., 100,000 to 8,000,000). Tier-2 providers may or may not have the aforementioned IPTV infrastructure that tier-1 service providers might have.

Tier-3 service providers are typically the smallest operators. Although tier-3 service providers may have their own physical access network they do not have long haul networks, and they typically have only tens of thousands of access lines (e.g., less than 100,000 access lines). Tier-3 also do not have all the necessary system components for providing the managed service that higher tiers can provide.

Thus, for simplicity, the various types of service providers (e.g., cable-MSO, common carriers, satellite operators, etc.) are collectively referred to as ‘service providers.’ Along these lines, the high tier service providers are generically referred to as ‘tier-1 telcos’ and low tier service providers are generically referred to as ‘tier-2,3 telcos.’

In one instance, as shown in FIG. 1, the service providers employ an IPTV-based system 10 which embodies an IPTV-based transport system architecture set up for delivering video content from content providers 20. Although we frequently refer here to video, the content can be in the nature of multimedia with any combination such as (i) text and sound, (ii) text, sound, and still or animated graphic images (iii) text, sound, and video images, (iv) video and sound, (v) multiple display areas, images, or presentations presented concurrently, or (vi) in live broadcast/display, a speaker or actors and “props” together with sound, images, and motion video.

For live video content, IPTV-based systems typically use multicasting with Internet group management protocol (IGMP); and for VoD they use real-time streaming. For increased use of the bandwidth, compatible data compression standards use various data transform and coding techniques. Data compression standards include MPEG (moving picture expert group) and H.264 standards for digital video and audio compression. The playback of IPTV data requires a set-top box connected to a television set (TV) or a computer with compatible digital data decompression tools. Typically, the video content transport stream delivered via the IP multicast to set-top boxes of subscribers is in MPEG-4 part 10 or H.264 format. In standards-based IPTV systems, an underlying protocol for the transport stream of live TV is, for instance, version 2 of the aforementioned IGMP and for transport stream of VoD the protocol is RTSP. Thus, with encryption and end-to-end conditional access, the video content can be transported seamlessly to the set-top boxes 32 via the operator's network or the central office head-end 28 outer layer decryption 40a.

As illustrated, the content providers send video content to a receiving satellite dish antenna 22 associated with a network operations center 23. Through each satellite, the content providers send video content for multiple channels. In this particular instance, the network operations center 23 is a fully integrated satellite broadcast center that includes an IPTV-based satellite acquisition and distribution hub with as many as 1000 channels per satellite or more. The network operations center 23 includes also IPTV software, encoding system, conditional access system (using encryption and/or scrambling methods) and network monitoring center. A first encryption engine 34 in the network operations center performs inner-layer encryption of the content, an encapsulation engine 36 encapsulates the encrypted content and a second encryption engine 38 performs outer-layer encryption of the encapsulated encrypted content.

The double-layer encryption (inner and outer layer encryptions 34, 38) and the encapsulation 36 are performed in the network operations center 23 prior to transmitting the signals over a satellite in orbit 24. Thus, from the network operations center the satellite in orbit 24 relays this data to locations around the globe in encapsulated double encrypted form rather than in the clear.

As described in more detail below, encapsulation reassigns the IP-addresses of alternate channels so that they end up with the same IP address as the main channel. Often times, the IP addresses are multicast addresses, as further shown in our examples, although other transmission protocols are possible using for instance unicast addresses and the like. The alternate channels replace the main channels during blackout. Then, because IP packets of video content (e.g., TV programs) from one or more channels map to corresponding unique program identifiers (PID) a receiver at the other end of the satellite link can, upon command, turn off/on programs with certain PID. That is, in an IPTV-based system with encapsulation both main and alternate programs have the same IP-multicast address and are destined to the same receiver at the other end of the satellite link. Then, for a particular zip code the receiver can turn off/on main/alternate programs to manage blackout seamlessly.

From the Satellite link 24 the transmitted information is carried over to an array of receiving antennas. One such receiving antenna 26 is shown associated with the central office head-end 28 (part of a service operator's national network of satellite dish antennas) for receiving the incoming video content. When a cable company provides also broadband Internet and VoIP service to subscribers, the central office head-end includes cable modem termination system and a computer system and databases.

A decryption engine 40a in the central office head-end performs outer-layer decryption of the incoming content, and for high tier operators a second decryption engine 40b performs bulk inner-layer decryption before the content is securely handed off to the service provider's network for subsequent encryption and distribution to its subscribers, using its own conditional access system. From the head-end, the local stations video content (or programming) is carried over a local network of antennas 30 and it is then passed on, simultaneously with the content received from the satellite via IP multicast, to the many set-top boxes (STB) 32 of subscribers downstream.

In other words, the IPTV-based transport system architecture includes the double-layer (first and second) encryption engines at the network operations center and first and second decryption engines at the central office head-end in order to accommodate the tier-1 telco. Otherwise, for tier-2,3 telcos, the second decryption engine can be bypassed or turned off and, instead, the inner-layer decryption is performed by the set-top boxes at the subscribers' end. This is because not all service providers have the same physical infrastructure in that not all of them have the necessary encoding/decoding and other access management capability. Thus a single IPTV-based transport system architecture accommodates both tier-1 and tier-2,3 telcos.

What is further shown in FIG. 1 as an alternative mode of transporting the video content besides satellites is fiber connections. Fiber cables 42 connect the network operations center to the central office head-ends and are therefore accommodated in the overall design of the IPTV system platform.

Thus, from end to end, the IPTV-based system covers the content providers, the satellite communication or fiber transmission from the content providers to the network operations center, the global satellite communications from the network operations center, the central office head-ends, the local reception and distribution via service provider networks and reception by set-top boxes connected to TV sets. Accordingly, the end-to-end system can be viewed as a platform having transport functionality, and more specifically IPTV-based transport functionality as previously described. The IPTV-based transport architecture covers the network operations center with satellite acquisition and distribution hub, the global satellite network and satellite receiving head-ends. The upstream segment covers the content providers and link to the network operations center, and the downstream segment covers the central office head-ends, service provider networks and set-top boxes.

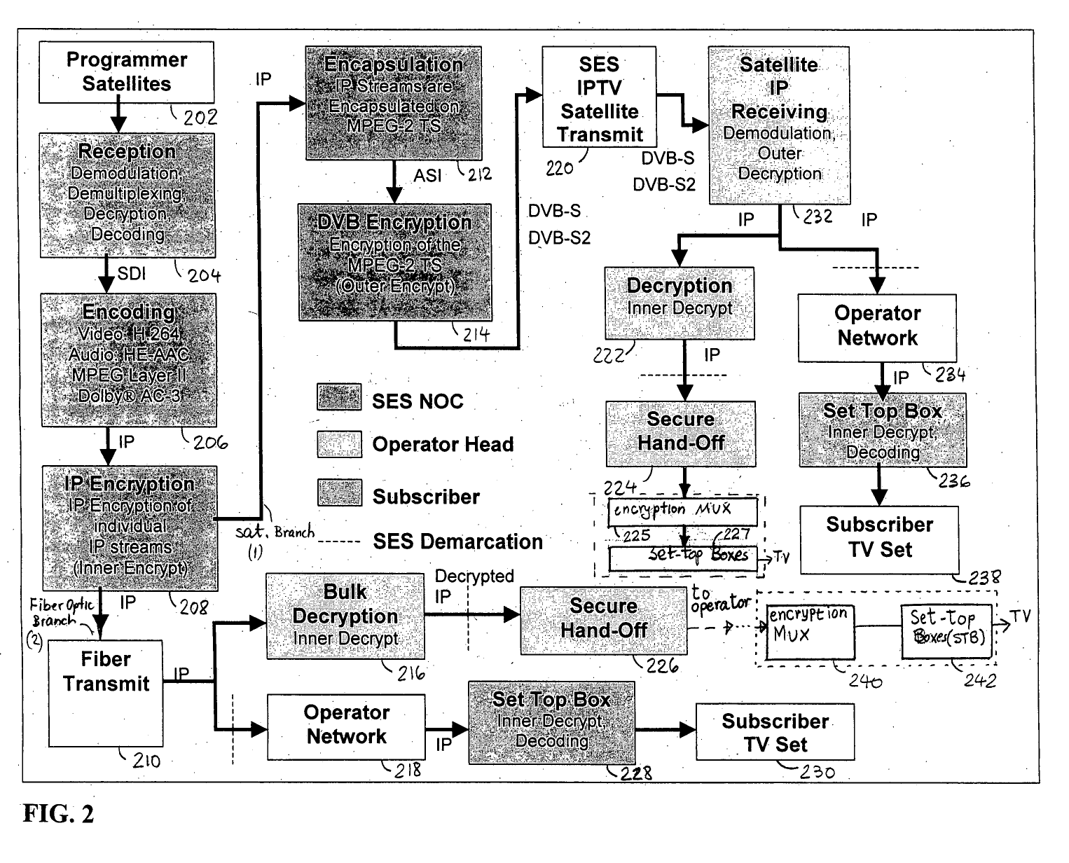

FIG. 2 further illustrates the flow of data through the various segments of the foregoing IPTV-based transport system from end to end. As shown, satellite antennas 202 of the content provider (or programmer) relay multimedia data, in this case video content data. At the network operation center, the incoming data, representing aggregate data from multiple TV channels, is received, demodulated, de-multiplexed, decrypted and decoded into SDI format 204. Serial Digital Interface (SDI) is a standard for digital video transmission over coaxial cable. The data in SDI format is delivered to an encoding (compression) system 206 where H.264 video compression is applied to the video stream and Dolby digital (AC-3) or MPEG-4 high-efficiency advanced audio coding (HE-AAC) encoding is applied to the audio stream.

To safeguard the video content data the IPTV-based transport system provides data encryption at the IP packet level. Specifically, the encoded (compressed) streams (IP packets) are passed on to an encryption engine 208 for inner-layer (IP) encryption of individual IP packets. A number of encryption method are possible, including symmetric (shared secret key with DES or AES) or asymmetric (RSA—public-private key pair). IP packet encryption prevents eavesdroppers from reading the data that is being transmitted. When IP packet encryption is used, IP packets can be seen during transmission, but the IP packet contents (payload) cannot be read.

From this point the inner-layer-encrypted packets can move across one of two paths in the transport system. We refer to these paths: (1) the satellite communications path, and (2) the fiber optics path, respectively.

As mentioned, one channel corresponds to the main national feed with the program to be blocked and other channel(s) correspond to secondary feeds with alternate program(s); and the content of such channels is packaged for transmission in IP packets that are encrypted. When distributing the IP packets through the satellite communications path, the encrypted IP packets are encapsulated for satellite transmission 212. The resulting encapsulated transport streams (transport packets) are compatible with ASI (asynchronous serial interface) standard that define the way devices interact with the physical and data link layers of the distribution system. An ASI link is typically a point-to-point link for, say, 25 channels (identified by their respective PID, e.g. 1, 2, . . . , 25). In this implementation, the data can be transmitted in MPEG-2 transport streams.

In generating the ASI-compatible transport packets the encapsulation of the encrypted IP packets involves division into segments of the encrypted IP packets and encapsulation of each segment with an envelope. Additionally, encapsulation can bundle streams from a plurality of channels, say 5 bundles each with 20 channels for a total of 100 channels, where each bundle is identified by a program identification (PID). In this instance the encapsulation forms content transport packets by dividing the encrypted IP packets into, say, 188-bit segments and encapsulating each with an envelope that includes a header. Preferably, the segments conform to the point-to-point transmission protocol, e.g. MPEG-2 Transport Stream protocol, and thus segments associated with the content of the same program share the same PID. This means that each header includes a PID that associates the segment to a particular program with such PID, where the PID corresponds to a particular program source address. This means also that each packet has a header with an original IP address, and the encapsulation re-addresses the IP addresses of all channels to the IP address of the main channel (main program feed), and inserts ahead of such header an outer header with the corresponding PID.

Specifically, the encapsulation inserts an outer header (in this example an MPEG-2 transport stream (MPEG-2 TS) header) next to and before the original IP header. This alters the normal IP routing for the transport packets and thereby delivers them to an alternate destination not otherwise specified in the IP destination address field of the original IP header. In addition to the PID (channel source address), the outer header may include CRC error control, payload size, and other packet information that is used at the receiving end for de-encapsulation.

At the destination, the receiving head-end performs the de-encapsulation. This operation yields the original (inner) IP destination address, by exposing the header with its re-addressed IP address and then using the transport packets whose header contains the same PID to reconstruct the original IP packet. In other words, de-encapsulation re-assembles the IP packet from the segments based on the information in the exposed header.

For blackout management in connection with the delivery of sports content or other events content over IPTV networks, encapsulation such as the one described above addresses substitute programs to the same destinations as the live telecasts. To this end, the network operations center receives from the programmer (content provider) both the live telecast and alternate programming channels via the programmer's national main feed and alternate feed, respectively. The encapsulation gives the live telecast and alternate program the same IP multicast address (e.g., 239.1.1.1). Then each of the ASI-compatible data transport streams maps to a program identification (PID) where, even if multiple signals are multiplexed and bundled into one transport stream they represent only one program that is associated with the PID instead of multiple channels. The programmer sends the main and alternate feeds so that it can control the transport streams and determine which markets experience the blackouts. This way, the program can be identified individually by the receiving head-end, which is commanded to turn off the live telecast program associated with a particular PID and turn on the alternate program associated with another PID.

The central management system for receiving head-ends has interfaces to programmers' schedulers. These schedulers can be automated systems that originate the blackout commands. Via these interfaces, the schedulers can send a command to a particular receiver, identified by a zip code, to black out that zip code area by switching ‘off’ the main feed channel for the program associated with the PID indicated in the command. Another command, or the same command, instructs such receiver to switch ‘on’ the alternate feed with PID associated with the alternate program. Alternatively, the content providers interface with the network operations center via email, fax or other means to indicate their programs blackout schedule and designated zip code areas. This information is processed by the network operations center to produce blackout commands that are handled in the aforementioned manner.

Thus, the encapsulation (with transport packet readdressing) in combination with the blackout (on/off PID) commands allows programmers (content providers) to control blackouts in wireless and satellite distribution systems. By turning off/on programs associated with PIDs, the IPTV-based transport system platform offered by the present invention provides a seamless and transparent switchover from main live telecast to alternate programming channels.

To complete the process, this platform offers the second layer of encryption in order to accommodate tier-1 telcos, as previously explained. Thus, for the outgoing encapsulated IP packets the second encryption is the outer layer encryption 214. Each bundle of streams is encrypted as one unit instead of encrypting each of its streams individually, and the decryption engine in the receiver at the other end of the satellite relay does not need to know how many channels are bundled in each group. Note that if the inner and outer layer encryptions are similar symmetric encryption methods they each use a different encryption key. The encryption keys for both would be automatically generated and rotated periodically for additional protection.

In one instance, the outer layer encryption is a scrambling algorithm for conditional access associated with digital video broadcasting (DVB) standards. The outer-layer encryption involves DVB-S and DVB-S2 standards for digital television satellite broadcasting. DVB is a suite of internationally adopted operating standards for digital television published by the European Telecommunications Standards Institute (ETSI) and others. Among these standards, the conditional access system (DVB-CA) defines a common scrambling algorithm (DVB-CSA) and a common interface (DVB-CI) for accessing scrambled content. DVB system providers develop their proprietary conditional access systems within these specifications. Although not presently used, DVB transports may include metadata called service information (DVB-SI) that links the various elementary streams into coherent programs and provides human-readable descriptions for electronic program guides.

Again, the IPTV-based transport system includes the double layer encryption and bulk decryption features in order to accommodate the tier-1 telcos and lower tier telcos (tier-2,3 telcos) without customizing the architecture for each type of telco. This way, lower tire telcos can take advantage of the conditional access capability offered by the IPTV-based transport system while high tier telcos can use this same system and still use their proprietary infrastructure.

To this end, from the network operations center, the satellite in orbit 220 relays signals modulated with the double-encrypted IP packets to the satellite receiving head-end 232. At the head-end, the received signals are demodulated to yield the double-encrypted packets. Also at the head-end, the double-encrypted IP packets undergo decryption which ‘peels off’ the outer layer encryption from the incoming IP packets. Moreover, each peeled IP packet is associated with a PID which the receiving head-end can then identify and turn on/off upon command from the programmer in a manners explained above.

For tier-1 telcos, the path on the left branch will pass on the resulting inner-layer-encrypted IP-packets to a bulk decrypter 222. The bulk inner-layer-decryption will expose the IP packets, which are then securely handed off to the tier-1 telco (high tier service provider) network 224. Then, the exposed IP packets can be encrypted again by the tier-1 telco using whatever proprietary methods it has for controlled access. As noted before, each of the IP packets can actually include bundled streams from a group of channels. Therefore, the tier-1 telco can distribute individual IP streams from the different channels by unraveling the bundles of incoming IP packets and distributing each of the IP streams at a time using a multiplexing scheme 240. The IP packets are then relayed via the tier-1 telco network to the set-top boxes 242 and their associated TV sets. The controlled access is achieved with the set-top boxes being able to decrypt only those of the incoming IP packets which they are authorized by the telco to receive.

Indeed, the tier-1 telco system is set up so that along the entire path from the content providers (programmers) to its subscribers' set-top boxes the video content is protected and never stored or distributed in the clear. After bulk decryption and secure handoff, the video content is encrypted at the content provider head-end and only decrypted at the viewer's home.

As for tier-2 and tier-3 telcos, the path on the right branch leads directly to the service provider's network 234 without any intervening bulk decryption (namely, the bulk encryption is off). This is because the lower tier telcos do not have their own encryption and secure handoff facility and the only way to keep the content protected is to transport it through the network in encrypted form. The encryption is ‘peeled off’ by the set-top boxes 236 before they reach the TV 238 but only if they are subscribers and authorized to receive and descramble the TV programs. Here too the content is protected along the entire path from the programmers to the set-top boxes except that in the case of lower tier telcos the inner layer encryption was applied at the network operations center before the satellite relay and it is retained until the content 238 reaches the set-top boxes.

Along the aforementioned fiber path (2), there are again two branches, one (upper) for tier-1 and another (lower) for the tier-2 and tier-3 telcos. The difference, of course, is the means (fiber) of transporting the IP packets from the network operations center to the telcos head-end. As before, the bulk decryption 216 and secure hand off 226 are suitable for the tier-1 telco (upper branch). Then again, the direct handoff to the operator's network (in encrypted form) is suited for the lower tier telcos (lower branch).

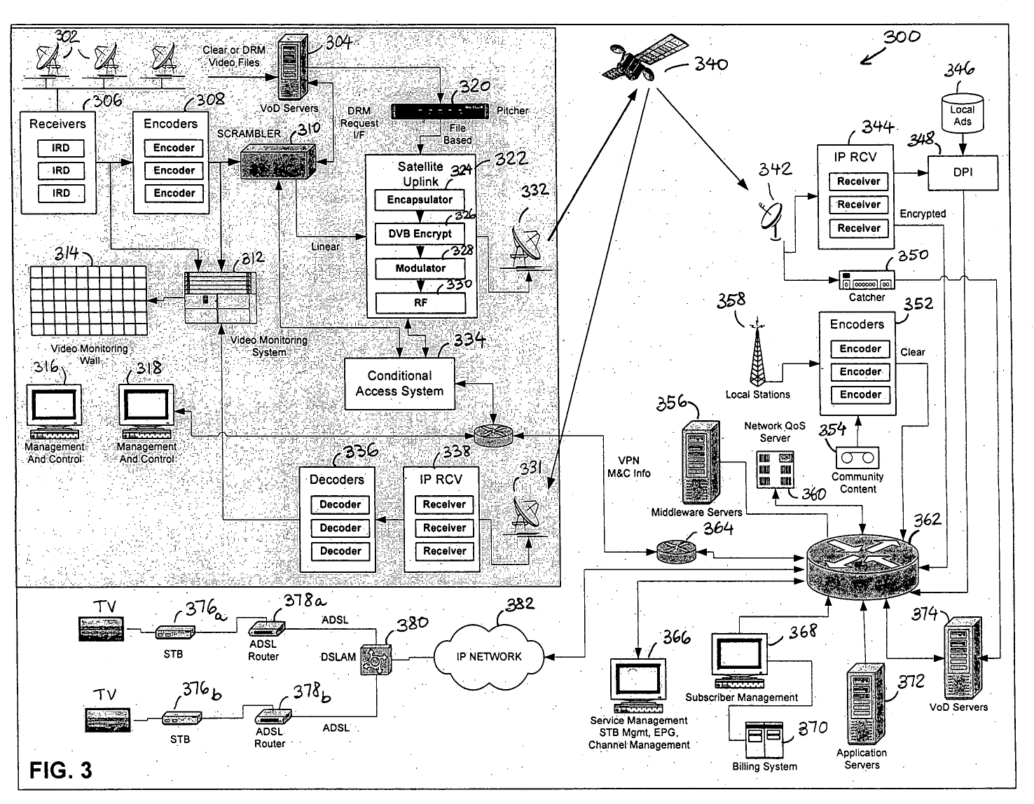

To further illustrate the foregoing, FIG. 3 is a diagram of an IPTV-based system embodying the encapsulation and double-encryption and bulk encryption features. Briefly, in this illustration for TV programming the video content is obtained at any given time from two possible sources, live TV programming from content providers via antennas 302 and integrated receiver-decoder devices 306 or stored video from VoD servers 304 and pitcher 320. The pitcher retrieves requested video files and creates multicast IP packets. The live video content passes through a scrambler 310 and from there it is sent for inner layer encryption at a conditional access system 334. File-based IP streams from the pitcher 320 or linear IP streams from the scrambler move on to the satellite uplink 322 for encapsulation 324, outer layer encryption (DVB) 326, modulation 328 and microware frequency up-convert and power amplification 330. The encapsulation engine 324 inserts the IP address of the main feed channel destination and creates ASI-compatible transport streams sent as IP packets with each program associated with a PID. The satellite in orbit 340 relays the double-layer-encrypted IP packet to the receive head-end with associated antenna 342 and IP receiver 344.

Again, for tier-1 telco bulk decryption is applied to the incoming IP packets (multi-channel bundles) and the telco's own proprietary encryption is then applied. For tier-2,3 telcos, the bulk decryption is off (or bypassed). Either way, the IP packets are distributed through the operator's network in encrypted form. Local stations programming 358, community content 354 and advertising 346, however, are free and provided in the clear. For VoD, the catcher 350 receives the incoming multicast IP packets and assembles the video files. The VoD servers 274 handle the storage and distribution of these files to subscribers through the network. For distribution, the various signals are multiplexed 362 and passed on to the service provider's network 382 and eventually, the IP packets arrive at the set-top boxes 376a-b. The middleware server 356 controls the inner-layer decryption at the set-top boxes in conjunction with the subscriber management as well as service, set-top boxes, channel and billing management services 366, 368, 370. The channel management server 366 receives schedule information with instructions from the programmer to black out certain zip code areas, which it can translate to a command for turning off/on certain programming channels. The network quality of service (QoS) server 360 checks integrity of the incoming IP packets.

Incidentally, for monitoring the system integrity, the signals relayed by the satellite in orbit 340 are received also at the network operations center via antenna 331. The double-layer-encrypted IP packets are decrypted and decoded 338, 336 and passed on to the video monitoring system 312, 314. In addition to the video monitoring, the management and control systems 316, 318 perform the network operations control and management functions.

In sum, the present invention contemplates an IPTV-based transport system with a new architecture that includes encapsulation and double-layer encryption and bulk decryption functionality. The new IPTV-based transport system architecture accommodates the various types of service provides without having to customize the system for each individual type of service provider. Although the present invention has been described in considerable detail with reference to certain preferred versions thereof, other versions are possible. Therefore, the spirit and scope of the appended claims should not be limited to the description of the preferred versions contained herein.

What is claimed is:

1. An IPTV-based (Internet protocol television-based) system for managing blackouts, comprising:
a receiver of content that includes a program and one or more than one alternate program with each program and alternate program having its associated program identification (PID);
an encapsulation engine operative to encapsulate packets of the content;
a satellite or wireless link; and
a transmitter operative to send the encapsulated packets via the wireless or satellite link, wherein the encapsulation re-addresses the packets of content with the result that the alternate program is addressed similarly to the program such that both are sent to the same destination and enable de-encapsulation to expose the packets of content and with the further result that, if the destination is designated for blackout of the program, the program and the alternate program are identified to the destination by their respective PIDs so that the destination can replace the program by the alternate program substantially seamlessly and transparently.

2. An IPTV-based system as in claim 1, wherein the re-addressing of packets re-assigns their IP addresses.

3. An IPTV-based system as in claim 1, wherein the encapsulation further enables a destination associated with a particular zip code area to de-encapsulate the encapsulated packets and use information exposed therefrom to respond to blackout commands directed to that zip code area by turning off a channel identified with the PID of the program and turning on a channel identified with the PID of the alternate program.

4. An IPTV-based system as in claim 3, further comprising a scheduling system, wherein the blackout commands originate with a programmer that also provides the content or with the scheduling system based on scheduling information provided by the programmer.

5. An IPTV-based system as in claim 1, wherein the content includes streams from multiple channels, one channel associated with the program and another channel associated with the alternate program, and wherein the encapsulation engine is operative to bundle streams from groups of channels.

6. An IPTV-based system as in claim 5, wherein each packet has a header with an original IP address, and wherein the encapsulation engine is further operative to insert ahead of such header an outer header with an IP address of the program destination such that de-encapsulation would expose the header with its original IP address.

7. An IPTV-based system as in claim 1, wherein the transmitter is operative to send the encapsulated packets in double-layer-encrypted form to at least one of high-tier and low-tier service provider networks.

8. An IPTV-based system as in claim 7, further comprising:
an inner layer encryption engine operative to perform inner-layer encryption of received content; and
an outer layer encryption engine operative to perform outer layer encryption of inner-layer-encrypted content in order to produce double-layer-encrypted content so that decryption thereof would yield the inner-layer-encrypted content for acquisition by one of the low-tier service provider networks, wherein bulk decryption of the yielded inner-layer-encrypted content would expose the content for acquisition by one of the high-tier service provider networks.

9. An IPTV-based system as in claim 7, wherein the high-tier service provider network includes a secure handoff for passing the exposed content and a conditional access system with encryption capability.

10. An IPTV-based system as in claim 7, wherein the low-tier service provider network is operative to carry therethrough the inner-layer-encrypted content so that the content remains protected.

11. An IPTV-based system as in claim 1, wherein the destination has a receiving head-end operatively linked to TV (television) sets via set-top boxes, and wherein the set-top boxes have encryption engines for exposing the content and relaying it to their associated TV sets.

12. An IPTV-based system as in claim 1, wherein the content includes video, audio, audiovisual or multimedia.

13. An IPTV-based system as in claim 6, further comprising a fiber cable link for relaying the content obtained by the receiver and encrypted by the inner-layer encryption engine.

14. An IPTV-based system as in claim 1, wherein the encryptions to be performed in the inner layer encryption engine and outer layer encryption engine each using its own separate encryption key.

15. An IPTV-based (Internet protocol television-based) system for blackout management, comprising:
a satellite or wireless link for relaying content in packets which undergo encapsulation, the content including a program and an alternate program;
a destination with a receiving head end operative to receive from the satellite or wireless link the packets of content, wherein the encapsulation re-addresses the packets with the result that the alternate program is addressed similarly to the program such that both are received at the same destination, and wherein, at the destination, de-encapsulation exposes the packets of content and, if the destination is designated for blackout of the program, the program and the alternate program are identified to the destination by their respective PIDs so that the destination can replace the program by the alternate program substantially seamlessly and transparently.

16. An IPTV-based system as in claim 15, wherein the re-addressing of packets re-assigns their IP multicast addresses.

17. An IPTV-based system as in claim 15, wherein the receiving head-end is associated with a particular zip code area and operative to respond to blackout commands directed to that zip code area by turning off a channel identified with the PID of the program and turning on a channel identified with the PID of the alternate program.

18. An IPTV-based system as in claim 17, further comprising a scheduling system and wherein the blackout commands originate with a programmer that also provides the content or with the scheduling system.

19. An IPTV-based system as in claim 15, wherein the content includes streams from multiple channels, one channel associated with the program and another channel or channels associated with the alternate programs, and wherein the encapsulation encapsulates each of the channels into IP packets, each with its own IP address.

20. An IPTV-based system as in claim 15, wherein each packet has a header with an original IP address, and wherein the encapsulation inserts ahead of such header an outer header with an IP address of the program destination such that de-encapsulation would expose the header with its original IP address.

21. An IPTV-based system as in claim 15, wherein the receiving head-end is operative to receive the encapsulated packets in double-layer-encrypted form for delivery to at least one of high-tier and low-tier service provider networks.

22. An IPTV-based system as in claim 21, wherein the receiving head-end is associated with:
an outer layer decryption engine operative to perform outer layer decryption of the received double-layer-encrypted packets to yield inner-layer-encrypted packets for acquisition by one of the low-tier service provider networks; and
an inner layer decryption engine operative to perform bulk inner-layer decryption of the yielded inner-layer-encrypted packets in order to expose the content for acquisition by one of the high-tier service provider networks.

23. An IPTV-based system as in claim 21, wherein the high-tier service provider network includes a secure handoff for passing the exposed content and a conditional access system with encryption capability.

24. An IPTV-based system as in claim 21, wherein the low-tier service provider network is operative to carry therethrough the inner-layer-encrypted packets so that the content remains protected.

25. An IPTV-based system as in claim 22, further comprising TV (television) sets and associated set-top boxes with encryption engines for exposing the content from the inner-layer-encrypted content and relaying it to their associated TV sets.

26. An IPTV-based system as in claim 15, wherein the content includes video, audio, audiovisual or multimedia.

27. An IPTV-based system as in claim 15, further comprising a transmitter and transmission medium for relaying the double-layer-encrypted content from the transmitter, the transmission medium being one or more wireless antennas, fiber optic cables, or satellites and associated satellite antennas, or a combination thereof.

28. An IPTV-based system as in claim 15, wherein the receiving head-end is associated with a de-encapsulation engine operative to de-encapsulate the yielded inner-layer-encrypted packets to unbundled them into separate streams associated with individual channels.

29. An IPTV-based system as in claim 28, wherein the de-encapsulation engine is further operative to remove from the yielded inner-layer-encrypted packets an outer header with a program's IP address and expose an original header with its original IP address.

30. An IPTV-based system as in claim 22, the inner and outer layer encryptions each using its own separate encryption key.

31. A method for managing blackouts of content distributed in an IPTV-based system, comprising:
receiving content that includes a program and one or more than one alternate program;
performing encapsulation on packets of the content, wherein the encapsulation re-addresses the packets with the result that the alternate program is addressed similarly to the program such that both are sent to the same destination and enable de-encapsulation at this destination to expose the packets of content and with the further result that, if this destination is designated for blackout of the program, the program and the alternate program are identified to this destination by their respective PIDs so that the destination can replace the program by the alternate program substantially seamlessly and transparently; and
sending the packets in encapsulated form to the destination via a wireless or satellite link.

32. A method for managing blackouts as in claim 31, wherein the re-addressing of packets re-assigns their IP multicast addresses.

33. A method for managing blackouts as in claim 31, wherein at the destination there is a receiving head-end associated with a particular zip code area and, wherein the method further comprises responding to blackout commands directed to that zip code area by turning off a channel identified with the PID of the program and turning on a channel identified with the PID of the alternate program.

34. A method for managing blackouts as in claim 33, wherein the blackout commands originate with a programmer that also provides the content.

35. A method for managing blackouts as in claim 31, wherein the content includes streams from multiple channels, one channel associated with the program and another channel associated with the alternate program, and wherein the encapsulation bundles streams from groups of the channels into the IP packets.

36. A method for managing blackouts as in claim 31, wherein each packet has a header with an original IP address, and wherein the encapsulation inserts ahead of such header an outer header with an IP address of the program destination such that de-encapsulation would expose the header with its original IP address.

37. A method for managing blackouts as in claim 31, wherein the encapsulated packets undergo double-layer encryption before they are sent to the destination.

38. A method for managing blackouts as in claim 37, wherein for the double-layer encryption the method further comprises:
performing inner-layer encryption of the received content; and
producing a double-layer-encrypted content by performing outer-layer encryption of the inner-layer-encrypted content.

39. A method for managing blackouts as in claim 31, wherein at the destination there is a receiving head-end operative to receive the encapsulated packets in double-layer-encrypted form for delivery to at least one of high-tier and low-tier service provider networks.

40. A method for managing blackouts as in claim 39, further comprising decrypting the double-layer-encrypted content by performing outer layer decryption to yield the inner-layer encrypted content, wherein the low tier service provider networks carry the yielded inner-layer-encrypted content.

41. A method for managing blackouts as in claim 40, further comprising decrypting the yielded inner-layer-encrypted content by performing inner layer decryption to expose the content, the exposed content being securely handed off to a high tier service provider's controlled access system for re-encryption before being passed on to the high tier service provider network.

42. A method for managing blackouts as in claim 31, wherein the encapsulation further includes inserting an IP address header in each packet ahead of an original IP address header so that de-encapsulation would expose the original IP address header.
